(19) United States
(12) Patent Application Publication
(10) Pub. No.: US 2010/0047510 A1
(43) Pub. Date: Feb. 25, 2010

(54) Repositionable targeting reference for video screens

(76) Inventor: Philip Couvillion, Lafayette, LA (US)

Correspondence Address: Glenn Foreman, 311 N. Parkerson St., Rayne, LA, 70578, US

(21) Appl. No.: 12/454,423

(22) Filed: May 19, 2009

Related U.S. Application Data
(60) Provisional application No. 61/189,825, filed on Aug. 25, 2008.

(51) Int. Cl. B32B 3/02; B32B 3/10

(52) U.S. Cl. 428/66.5; 428/195.1

(57) ABSTRACT

A repositionable targeting reference for video screens comprised of transparent film material upon which a reticle is printed and which adheres to a video screen by virtue of static electrical attraction, a low tack adhesive coating, or other means.

This invention is related to Provisional Patent Application No. 61/189,825.

### BACKGROUND

1. Field of Invention

This invention relates to video gaming, specifically to a repositionable crosshair targeting reference for application to all video gaming system screens.

2. Background of the Invention

Video gaming systems necessarily use various types of video screens in order to provide users with visual feedback for their interaction with the video game software. In first person shooting style video games, the user interacts with the game in order to place shots on targets generated by the video game software. The user generally uses some sort of software generated crosshair targeting reference in order to place his shots on target. There are, however, some video games which do not provide a targeting reference onscreen. There are also situations where the user is unable to see the targeting reference, or where the targeting reference is inadequate for a variety of reasons. Therefore, there is a need for a tangible crosshair targeting reference which can be applied directly to the video screen by the user.

### SUMMARY OF THE INVENTION

Briefly, in one aspect of the present invention a transparent static cling film is provided upon which is printed a targeting reference, typically a crosshair or other reticle style generally used in aiming systems.

In another aspect of the invention a transparent low tack adhesive film is provided upon which is printed a targeting reference, typically a crosshair or other reticle style generally used in aiming systems.

Advantageously, in both aspects of the invention, articles of the invention can be applied to any video screen and can be repositioned, reused and removed without any harm to the screen. Use of the invention provides enhancement of game play in first person shooting style video games when the player is unable to see the standard targeting reference or in games where no targeting reference is provided.

### BRIEF DESCRIPTION OF THE DRAWINGS

FIG. 1 is a front view showing an article of the present invention as applied to a video gaming screen.

FIG. 2 is a front view of an article of the present invention.

FIG. 3 shows several examples of various targeting reticles which may be used in articles of the present invention.

FIG. 4 shows several additional examples of targeting reticles which may be used in articles of the present invention.

### DESCRIPTION OF THE PREFERRED EMBODIMENTS

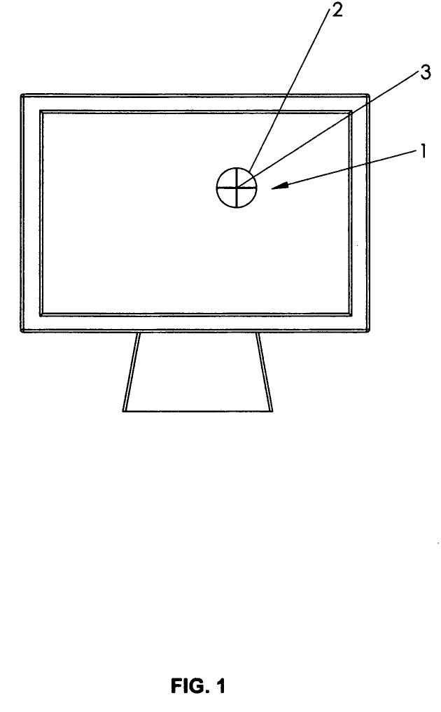

The present invention is a thin clear transparent sheet of a suitable dimension for variable positioning on video screens used for video gaming. Several embodiments of the present invention can be illustrated by reference to FIGS. 1-4.

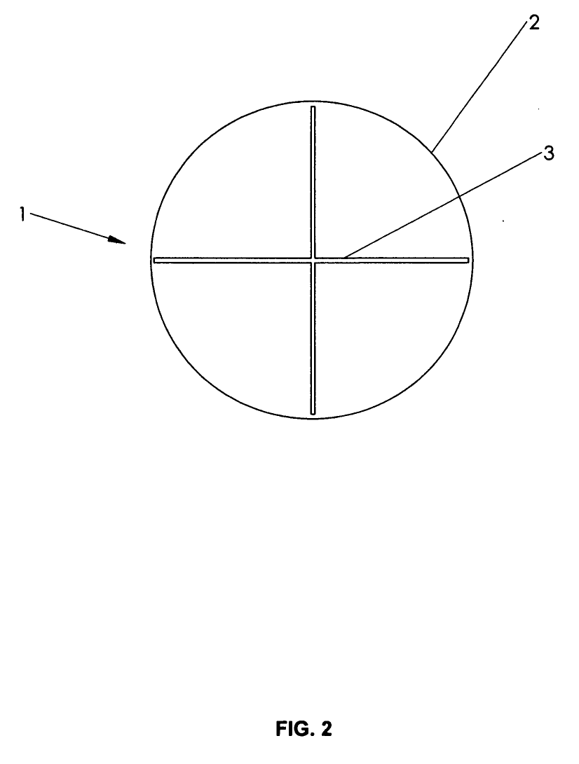

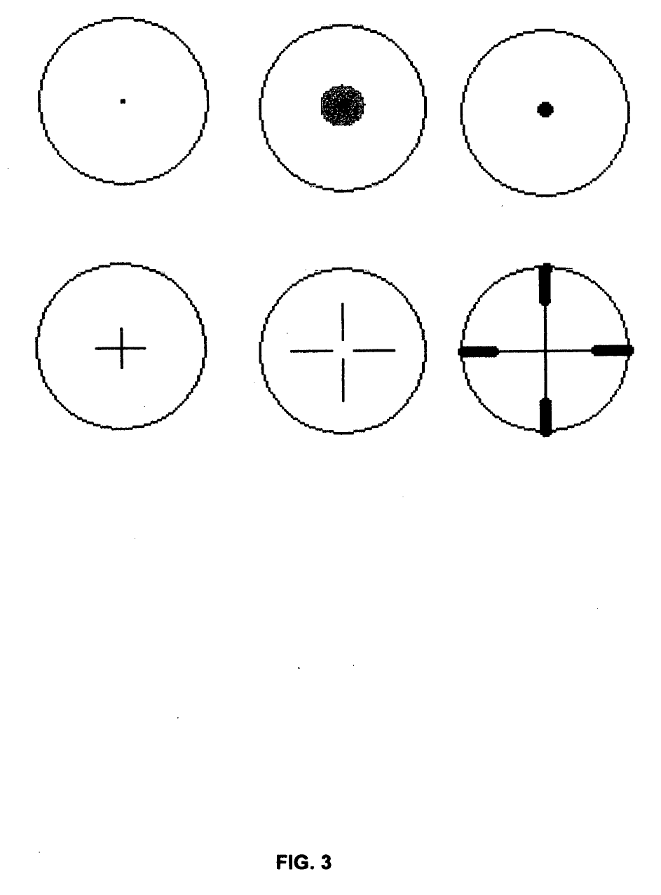

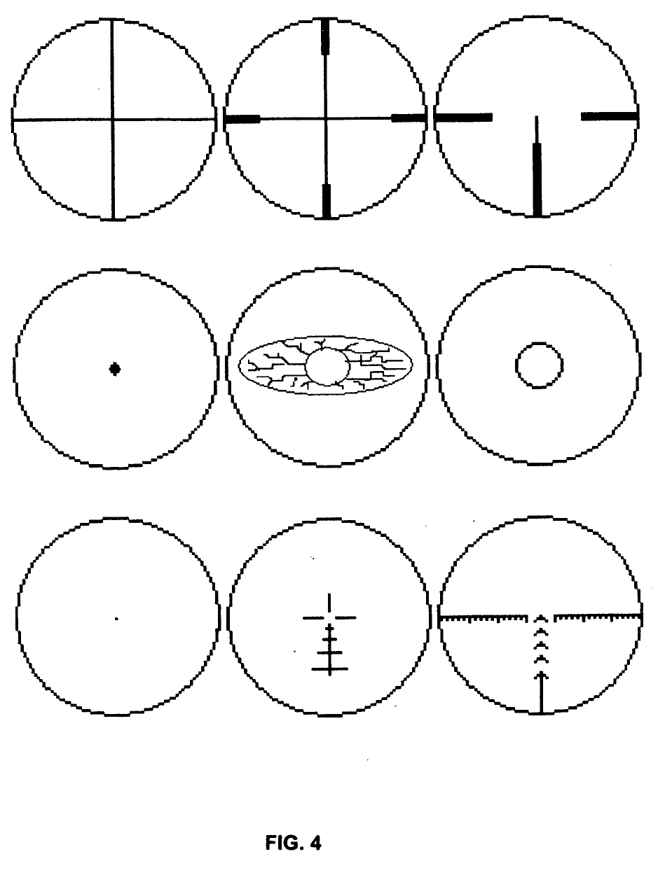

Referring to FIG. 2, a preferred embodiment of the present invention 1 is shown comprised of a thin flexible clear transparent sheet 2 preferably made of static cling film in order to allow the invention to adhere to a typical video screen surface by virtue of static electricity without the necessity of any adhesive backing. Typically the static cling film will be comprised of true static cling vinyl film, but any static cling film known in the art can be used in the this preferred embodiment of the present invention. For most uses, the film should be approximately 10 mils thick, but the present invention is not limited to that thickness, and can be made of either thinner or thicker materials known to those skilled in the art. A reticle 3 is printed on the front surface of the sheet in a contrasting color using any printing techniques known to those skilled in the art suitable for printing on such surface. In the preferred embodiment shown, the reticle is a crosshairs which is familiar in the art for an aiming reference, but as will be readily apparent to those skilled in the art, the reticle could be any of a variety of aiming references, nonlimiting examples of which are shown in FIG. 3 and FIG. 4.

In another embodiment of the invention, referring to FIG. 2, the thin flexible clear transparent sheet 2 is made of any flexible clear polymeric plastic film, the back surface of the sheet comprising a low tack adhesive coating providing a means of removably and repositionably attaching the sheet to any video screen. For most uses, the film should be approximately 10 mils thick, but the present invention is not limited to that thickness, and can be made of either thinner or thicker materials known to those skilled in the art. A reticle 3 is printed on the front surface of the sheet in a contrasting color using any printing techniques known to those skilled in the art suitable for printing on such surface. In the preferred embodiment shown, the reticle is a crosshairs which is familiar in the art for an aiming reference, but as will be readily apparent to those skilled in the art, the reticle could be any of a variety of aiming references, nonlimiting examples of which are shown in FIG. 3 and FIG. 4.

Typically, in both of the preferred embodiments of the invention, the size of the sheet is will range from approximately 1 to 3 inches in diameter, but the invention is not limited to this approximate size, nor is it limited to the typical round shape depicted in FIGS. 1-4, it being apparent to those skilled in the art that the size and shape of the invention is limited only by the limit of easy visibility on the small end of the range, and by the ability to have a manageably positionable size compared to the size of the video screen, on the large end of the range. Due to the large variety of sizes of video screens on which the invention can be applied, the typical size cited above for the preferred embodiments is nonlimiting.

Referring to FIG. 1, the preferred embodiment of the present invention 1 is shown as applied to a typical video screen as it would appear in a typical application of the invention.

What is claimed is:

1. Article of manufacture comprising
a transparent static cling film, said film being capable of adhering to a video screen by virtue of static electrical attraction between said film and said screen; said film having a thickness of approximately 10 mils; said film further having a width of between approximately 1 inch and approximately 3 inches; said film further having a length of between approximately 1 inch and approximately 3 inches, and
a reticle printed on said film,
whereby said reticle can be used as an aiming reference in video gaming activities.

2. The article of manufacture of claim 1 wherein the transparent static cling film is further comprised of true static cling vinyl film.

3. The article of manufacture of claim 1 wherein the transparent static cling film is substantially circular in shape having a diameter of between approximately 1 inch and approximately 3 inches.

4. The article of manufacture of claim 1 wherein the reticle is defined as a scale on transparent material used especially for aiming.

5. The article of manufacture of claim 1 wherein the reticle is a crosshair pattern.

6. The article of manufacture of claim 1 wherein the reticle is a dot pattern.

7. The article of manufacture of claim 1 wherein the reticle is a post pattern.

8. Article of manufacture comprising
a transparent polymer film having a front surface and a back surface, the back surface further comprising a low tack adhesive coating, said coating being capable of removeably and repositionably adhering said film to a video screen by virtue of adhesive properties of said coating; said film having a thickness of approximately 10 mils; said film further having a width of between approximately 1 inch and approximately 3 inches; said film further having a length of between approximately 1 inch and approximately 3 inches, and a reticle printed on said film,
whereby said reticle can be used as an aiming reference in video gaming activities.

9. The article of manufacture of claim 8 wherein the transparent polymer film is substantially circular in shape having a diameter of between approximately 1 inch and approximately 3 inches.

10. The article of manufacture of claim 8 wherein the reticle is defined as a scale on transparent material used especially for aiming.

11. The article of manufacture of claim 8 wherein the reticle is a crosshair pattern.

12. The article of manufacture of claim 8 wherein the reticle is a dot pattern.

13. The article of manufacture of claim 8 wherein the reticle is a post pattern.

14. Article of manufacture comprising
a transparent film, means for removeably and repositionably adhering said film to a video screen, and
a reticle printed on said film,
whereby said reticle can be used as an aiming reference in video gaming activities.

15. The article of manufacture of claim 14 wherein the transparent film is substantially circular in shape having a diameter of between approximately 1 inch and approximately 3 inches.

16. The article of manufacture of claim 14 wherein the reticle is defined as a scale on transparent material used especially for aiming.

17. The article of manufacture of claim 14 wherein the reticle is a crosshair pattern.

18. The article of manufacture of claim 14 wherein the reticle is a dot pattern.

19. The article of manufacture of claim 14 wherein the reticle is a post pattern.
